(19) United States
(12) Patent Application Publication
(10) Pub. No.: US 2013/0073942 A1
(43) Pub. Date: Mar. 21, 2013

(54) Method, System, and Computer-Readable Medium To Uniformly Render Document Annotation Across Different Comuter Platforms

(71) Applicant: Aleksey G. Cherkasov, Covington (GE)

(72) Inventor: Aleksey G. Cherkasov, Covington (GE)

(21) Appl. No.: 13/616,213

(22) Filed: Sep. 14, 2012

Related U.S. Application Data
(63) Continuation of application No. 11/783,912, filed on Apr. 13, 2007.
(60) Provisional application No. 60/792,315, filed on Apr. 14, 2006.

(51) Int. Cl. G06F 17/00

(52) U.S. Cl. 715/233

(57) ABSTRACT

A computer-implemented method, system, and computer-readable medium to uniformly display electronic annotations of a document across differing computer platforms of an imaging system where documents are stored as images on an image file server. An exemplary method comprises a user producing a textual representation of a document annotation, generating an image and associated attributes (e.g., size, location, color, etc.) of the annotation, storing the annotation image in a record of an annotation file, and accessing the annotation file record to retrieve the annotation image in a standard universal format whereby to render a combined image representation of the document overlaid with the annotation image according to the attributes. Standard formats include jpeg, gif, tiff, or Windows metafile. Instead of storing the annotation image in the record, a pointer may be stored in the record to enable retrieval of the annotation image from another memory location.

### CROSS-REFERENCE TO RELATED PATENTS AND PATENT APPLICATIONS

This is a continuation of U.S. application Ser. No. 11/783,912 filed Apr. 13, 2007 in the name of the same inventor hereof, which claims the benefit of Provisional Application Ser. No. 60/792,315 entitled “Document Management System, Method, and Computer-Readable Medium o Effect Implementation Thereof,” filed Apr. 14, 2006, which application in its entirety is incorporated by reference herein.

### BACKGROUND

This invention relates to document or file management, but more specifically, to a method, system, and computer-readable medium to manage, control, or maintain successive versions of a document comprising multiple overlaid image fields or components, i.e., a compound document.

In the context of document or file management, a compound document comprises multiple segments or component files that are visually overlaid so that it appears on a display monitor as a single image. Each component file of the compound document may comprise text or pictures intermingled with multimedia annotations (text or graphic) such as pictures, digital audio or video, and/or other content. In a document management system, an image processor accesses each component file from memory and combines them to form a single image representation of the document. Segmentation of the respective image fields is generally transparent to the user. During work-flow processing, however, any subpart of a compound document may be updated, such as by editing, adding or deleting a file and thus, version management may become challenging. Together, multiple electronic image and/or text files comprising a set of component files that make up the compound document are herein called an “ImageSet.”

To facilitate work flow processing during file management, it is desirable to control or track versions of each individual component of a compound document. Present day document or file management systems, however, do not conveniently provide this ability. No prior system is known that allows for versioning of the individual component files of the ImageSet independently from each other or independently from the ImageSet as a whole.

The present invention, on the other hand, provides an audit trail for changes made to individual “ImageData” files comprising the ImageSet, i.e., the compound document as a whole. Advantageously, version control affords the user the ability to conveniently revert back to a previous version of a compound document. For example, the present invention allows a user to start with a single text document, later add an image overlay or annotation to the document, and then keep adding annotations to the overlay over a period of time as well as to modify content of the text document. Later, the user may trace all changes made to the collection of electronic documents by observing how they took place in chronological order. The user will thus be able to access previous states of the compound documents and to see them in the context of the collection at each point in time.

This invention also relates to a file management, but more specifically, to a method, system, and a computer-readable medium to effect uniform display or rendering of document annotations across multiple computer platforms.

To assist in work-flow processing of files in a document management system, it is convenient to add annotations, pictures, hyperlinks, or multimedia content to document files. This helps the user to mark relevant portions and electronically annotate documents with electronic “sticky” notes, highlights, arrows, markers, free-form text and other graphical marks. Electronic annotations also include redaction capabilities for censoring sensitive documents. Generally, electronic annotations are stored in a separate file (called an “annotation file”) and are overlaid over the document image when displayed or rendered on a computer monitor. This way, the original document image is never directly altered. Optionally, the annotations may be “burned-in” the document image, that is, permanently overlaid or written onto the document image and become a permanent part of the image file of the original document. Under the permanent alteration options, once annotations are burned-in, the original image becomes altered and annotations become a permanent part of the image.

Prior systems including those commercially available from Accusoft, Adobe and PixelTranslation have one common problem; some annotations do not preserve their appearance from one machine to another, e.g., across different computer platforms that vary in operating system, configuration, and/or display/rendering applications. In a majority of cases, this problem was found to be related to machine setup, such as fonts that are missing or that differ from the annotations when originally authored on a different computer. In some cases, the appearance of annotation was so dramatic that the annotations either were read improperly or were completely unreadable.

ImageGear includes the AccuSoft Redlining Toolkit™ (ART), which is believed to be the standard for annotation technology. The ART component provides the ability to annotate images and documents with “sticky” note attachments, highlights, arrows, markers, free-form text and other indicators. It also includes redaction capabilities for censoring sensitive documents.

Hummingbird ImageBASIC provides an image annotation engine that may read and write Eastman/Wang® annotations, read and convert Watermark® annotations and, read Pixel Translations® annotations. Hummingbird's annotations are layered and preserved in groups so that they can be integrated with a security system and displayed only to authorized users. Annotations may also be stored in the header data of a tiff file, or in a separate database. In either case, the file may be sent or displayed with or without annotations.

Snowbound is another commercially available annotation package which is described at http://www.snowbound.com/flexsnap_webtop/webtop_annotations.html.

The foregoing systems and methods, however, do not uniformly display or render annotations across different computer platforms. The present invention seeks to solve this and other problems by providing consistent annotation marks across multiple computer platforms.

Prior systems do not provide this capability or other advantages of the present invention, which will become apparent upon reviewing of the following description taken with the accompanying drawings.

### SUMMARY OF THE INVENTION

A first aspect of the invention comprises a method of providing version management of a compound document in a document or file management system where the compound document includes at least two component files. The method comprises assigning a version number to the compound document, enabling a user to index the version number of the compound document according to a change in any one of the multiple component files thereof, assigning a respective component version number to respective ones of the component files, enabling a user to index the version number of the component files according to a change therein, maintaining a record of component version numbers associated with each version of the compound document, and retrieving a given version of the compound document by retrieving the associated versions of the component files. The method may be implemented in a multi-user document or file management system over a LAN or WAN network, and the component files of the compound document may be stored on a central networked file server either as text or images that are accessible by the multiple users.

Another aspect of the invention comprises a method of maintaining respective versions of a compound document that includes multiple component files that each have a respective version of their own. The method comprises providing a collective indicia of version for the compound document according to each unique set of component files; enabling a user to change a component file by adding, deleting, or editing any one of the component files; providing a record of each unique set of the component files for each unique version of the compound document; and retrieving a version of the compound document by retrieving each component file in a unique set associated with the unique version of the compound document.

A further aspect of the invention comprises a method of storing and retrieving a version of a compound document where a unique version thereof includes a unique set of component data files. This aspect comprises providing a primary version number for a compound document having an initial set of component data files, enabling a user to alter a component file, assigning a secondary version number for each altered component file, providing associated secondary version numbers of component files for each primary version number of said compound document, and retrieving a compound document having a desired primary version number by retrieving versions of component files having associated secondary version numbers.

Another aspect of the invention comprises a document or file management system to enable a user to maintain a version of a compound document having multiple component files. Such a system comprises a user interface to permit a user to assign a version number to a compound document having multiple component files, to index the version number of the compound document according to a change in any one of the multiple component files thereof, to assign a respective component version number to the multiple component files of the compound document, and to index the component version number according to a change in a component file; a memory to store a record of component version numbers that are associated with each version of the compound document, and a processor that responds to user commands to retrieve a given version of the compound document by retrieving the associated component files associated with said given version.

A further aspect of the invention comprises a document or file management system that maintains respective versions of a compound document comprising at least two component files that each have a respective version. Such a system comprises a user workstation to enable a user to provide an indicia for a version of the compound document according to each unique set of component files and to change a component file by adding, deleting, or editing the component file; a memory to store a record of each unique set of the component files for each version of the compound document; and a processor that responds to a user request to retrieve a version of the compound document by retrieving each component file in a unique set associated with the version of the compound document.

A further aspect of the invention comprises a file management system to store and retrieve a version of a compound document having unique versions that respectively include unique sets of component data files. Such a system comprises a workstation to enable a user to provide a primary version number for a compound document having an initial set of component data files, to alter a component file, to assign a secondary version number for each altered component file, to provide associated secondary version numbers of component files for each primary version number of said compound document, and to retrieve a compound document of a desired primary version number by retrieving component data files having secondary version numbers associated with said primary version number.

There is also provided an additional aspect of the invention in the form of a computer-readable medium for use in a document or file management system to store and retrieve a version of a compound document having unique versions that respectively include unique sets of component data files. The medium comprises program instructions to effect operation by a processor in a file management system to enable a user (i) to provide a primary version number for a compound document having an initial set of component data files, (ii) to alter a component file, (iii) to assign a secondary version number for each altered component file, (iv) to provide associated secondary version numbers of component files for each primary version number of said compound document, and (v) to retrieve a compound document of a desired primary version number by retrieving component data files having secondary version numbers associated with said primary version number.

Other aspects, features, and embodiments of the invention will become apparent upon review of the following description taken in connection with the accompanying drawings. The invention, though, is pointed out with particularity by the appended claims.

### BRIEF DESCRIPTION OF THE DRAWINGS

FIG. 1 shows a compound document comprising a text document file and a callout note file.

FIG. 2 conceptually illustrates interlinking between a compound document as a whole (i.e., an “ImageSet”) and respective component files (i.e., “ImageData files”) of the compound document.

FIG. 3 conceptually illustrates cross-referencing or interlinking between a compound document (“ImageSet”) and a version of a component file (“ImageData”) thereof.

FIG. 4 conceptually illustrates cross-referencing or interlinking between a Version 2 compound document (“ImageSet”) and respective versions of component files (“ImageData”) after adding an audio file to the compound document.

FIG. 5 conceptually illustrates cross-referencing or interlinking between a Version 3 compound document (“ImageSet”) and respective versions of component files (“ImageData”) after editing a document component of the compound document.

FIG. 6 conceptually illustrates cross-referencing or interlinking between a Version 4 compound document (“ImageSet”) and respective versions of component files (“ImageData”) after deleting the audio component from the compound document.

FIG. 7 show an apparatus the may be used to carryout the various methods and systems according to the invention.

FIG. 8 depicts a document image having an overlaid note.

FIG. 9 shows an annotation file having multiple records or marks that each characterizes an overlaid annotation.

FIG. 10 is a flow diagram illustrating a method according to an aspect of the present invention.

### DESCRIPTION OF ILLUSTRATIVE EMBODIMENTS

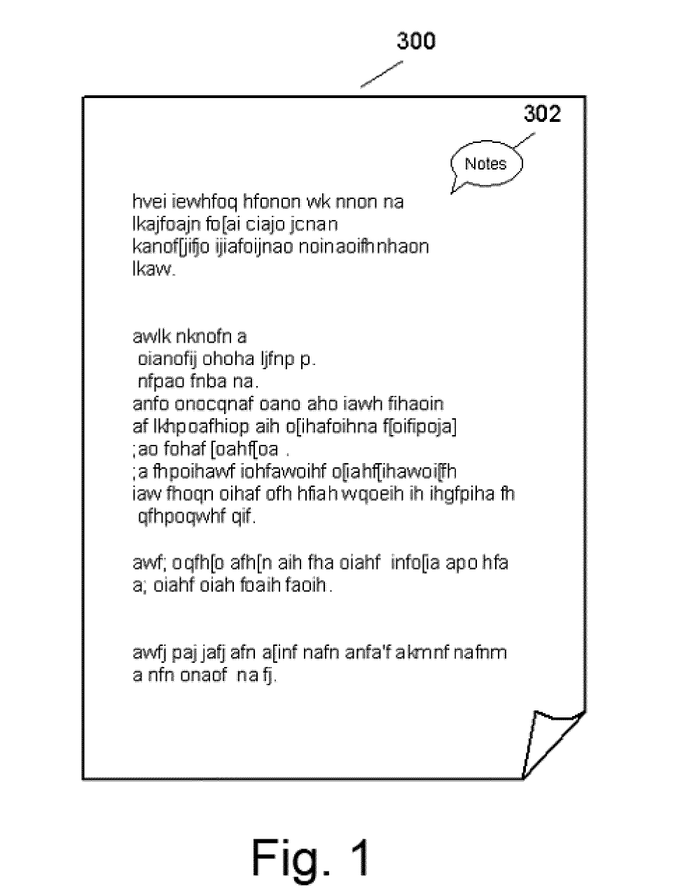

A compound electronic document (herein called an “ImageSet”) comprises multiple elementary documents or files, each of which is herein called an “ImageData” file. FIG. 1 shows an example of a compound document comprising a text document component 300 with a graphic annotation component 302 in the form of a callout note overlaid over the text component. Each subpart or component of the compound document is separately stored in memory as an image file that is typically accessed and retrieved during workflow processing in a document management system. Alternatively, a version of the compound document may be stored as a single file. Instead of text with a graphical callout, a compound document may also comprise a picture with graphical annotation marks applied to the document image and presented to a user as a single document (e.g., the user sees on a computer monitor the combined subparts as a single document).

Document 300 and annotation mark 302 overlaid therewith, however, are preferably stored as separate “ImageData” items, or data files. The two “ImageData” items of FIG. 1 comprise a single “ImageSet,” which may also include additional annotations or overlaid marks. Another example of a compound document is a text document with associated audio comments where the audio and text files are stored as separate “ImageData” items, one being stored as a digital audio file (e.g., in .wav format) and the other being stored as a text file in text format (e.g., .txt format). When rendered, the audio is played back upon viewing the visual component of the compound document. Because a compound document is a bundle of multiple individual files and because any one of the bundled files (including the principal document) may individually be altered or deleted, version control of the compound document becomes challenging. For example, it is difficult to determine how to identify or denote a particular version of a compound document in situations where any one of its subparts may be added, altered, deleted, or modified.

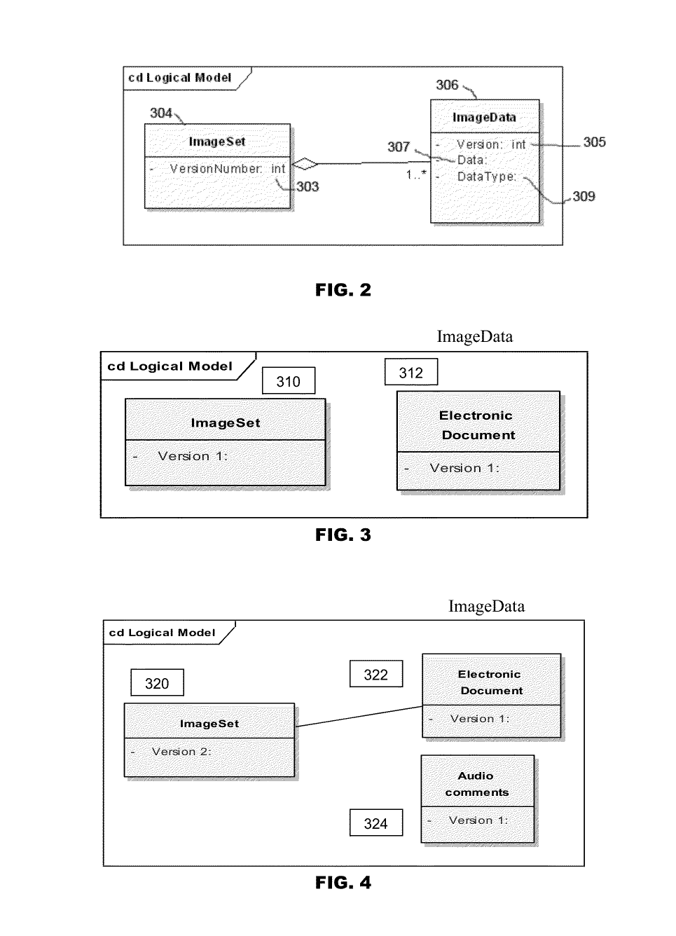

To provide an example of how the present invention is practiced, FIG. 2 conceptually illustrates a compound document denoted as ImageSet 304 having an integer field 303 to identify a version number for the compound ImageSet document. Any type of indicia (other than numbers) may be used to identify a version number. Typically, a memory location or database record identifies the whereabouts of the compound in memory storage, which may comprise a local or networked file server. Using conventional cross-referencing techniques, the compound document 304 is interlinked with each of its ImageData component files that make up the compound document, one being conceptually represented as ImageData file 306. Each ImageData file 306 also has an integer field 305 that specifies a version number, as well as image or text data 307 and a data type identifier 309. Only one ImageData file is shown in FIG. 2, it being understood that an ImageSet may comprise multiple ImageData or component files.

According to an aspect of the present invention, version control of the compound document is achieved by separately storing in a database record (or other memory storage) every version of the ImageSet 304 where each record (or storage location) references particular sets and versions of the ImageData files comprising the ImageSet 304.

For example, a user creates an electronic document and decides to place it into a document management system. As illustrated in FIG. 3, the system or method implementing version control responds by creating an ImageSet object 310 of Version 1 that cross-references a set of ImageData files 312 containing one or more electronic documents that constitute Version 1, e.g., a collective indicia of a version to reference the compound document and the callout note. ImageSet object 310, for example, may comprise a series of data records each corresponding to a respective ImageData file. As known in the art, computer implementation is achieved by a set of program instructions executed by a data processing system, which program instructions may be accessed or downloaded from a local or networked memory storage device.

At a later point in time, as illustrated in FIG. 4, a user decides to add audio comments to the compound document in order to create a new Version 2 ImageSet 320. Version 1 of audio comments created by the user is stored in memory as a separate audio file, but referenced by ImageData 324 as audio comments Version 1. ImageSet 320, however, references or comprises both Version 1 ImageData file 322 and Version 1 ImageData “Audio Comments” file 324. As previously indicated, separate ImageData files 322 and 324 may be separately stored in a database and referenced or called via string variables or by way of address pointers in data records of ImageSet 320.

To illustrate a potential typically challenge encountered during version management of a compound document, the user subsequently finds a spelling error in the Image Data “Electronic Document” file 322 and decides to correct it. Correction then produces a new Version 3 ImageSet file 330 that contains Version 2 “Electronic Document” file 332 of and Version 1 “Audio Comments” file 334, as shown in FIG. 5.

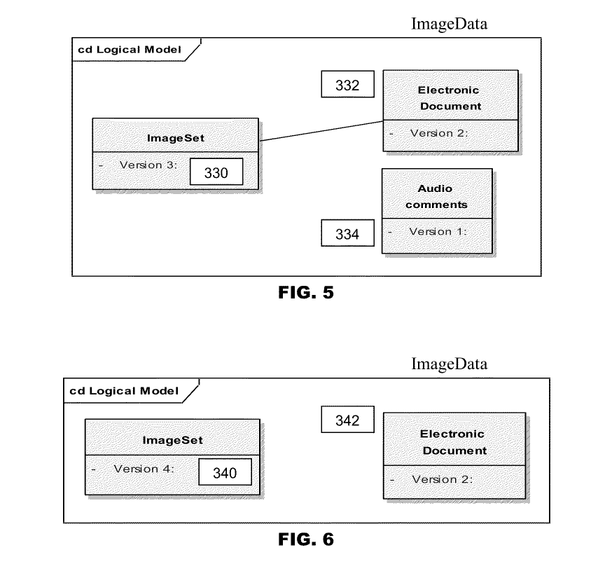

Finally, a user may decide to delete the ImageData “Audio Comments” file 334 whereby to create a new Version 4 “ImageSet” file 340 that references only the Version 2 “Electronic Document” ImageData file 342. This is illustrated in FIG. 6. During workflow processing, multiple users generally have access to the compound document over local or wide area network, and each such may make alteration or changes, thus further complicating version management.

As illustrated, a new ImageSet version number is created every time when at least one of the ImageData elements is modified, added to the ImageSet, or deleted from the ImageSet. According to various aspect of the present invention, the document or file management system tracks previous version of the compound ImageSet document and is able to retrieve exact versions of documents at any given moment of time. The illustrated system stores all versions of ImageData in a document or file storage memory device so that they may be recalled during version control or management.

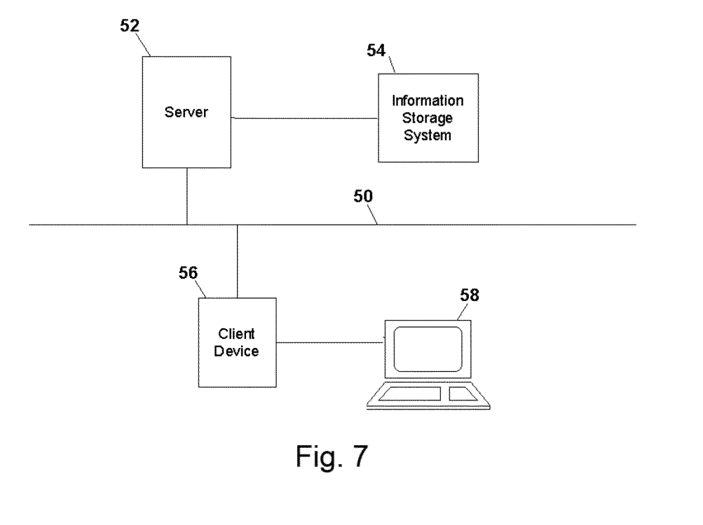

FIG. 7 shows a generic system in which the various methods may be implemented in a document or file management system. As illustrated, a network 50 provides a communication backbone for a workstation comprising a client device 56 and display monitor 58. Network 50 may comprise a local area network (LAN) or a wide area network (WAN), or a combination. Only one workstation is shown but a typical network supports many users. A server 52 on network 50 generally implements the document or file management system to manage compound documents stored on a central file server 54. Server 54 may comprise an image and/or text file server for the various component files of the compound document.

According to one embodiment of the invention, workstation 56, 58 includes a processor that responds to program instructions to provide a user interface to permit a user to assign a version number to a compound document having multiple component files, to index the version number of the compound document according to a change in any one of the multiple component files thereof stored locally in the client device 56 or stored on the central file server 54, to assign a respective component version number to the multiple component files of the compound document, and to index the component version number according to a change in a component file. Indexing may simply comprise increasing or decreasing an integer or decimal number to denote a version.

Either central file storage 54 or a local storage device 56 includes a memory to store a record of component version numbers that are associated with each version of the compound document. A processor included in the local client device 56 responds to user commands to retrieve a given version of the compound document by retrieving from memory the associated component files associated with said given version.

Any one of the component files may have version indicia, or also may be “fixed” in the sense of being permanently recorded or archived. A version number or indicia may include an integer or decimal number, an alphanumeric character, or any other symbol to designate or indicate a unique version of a document or file. Altering or changing a file includes adding, deleting, masking, annotating, editing, or any other operation that in any way changes or alters information in a component or subpart of a compound document. Accordingly, based on the teachings herein, the invention defined by the appended claims embraces variations and modifications of the disclosed embodiments as may come to those skilled in the art.

Glossary of terms used herein.

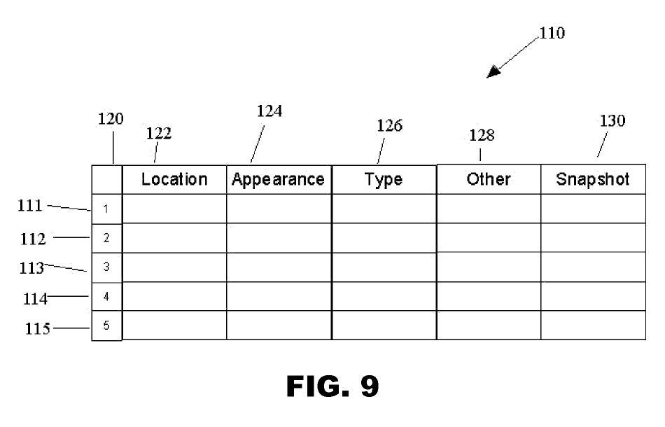

Annotation file—a file or block of memory (buffer) that stores information about annotation appearance and rendering rules, as illustrated in FIG. 9.

Annotation mark—a record in an annotation file that describes the appearance and rendering properties of a particular annotation mark. This information may include information about the font used (see “Font Information”)

Font—Typeface or a coordinated set of designs for characters, or a computer file that stores these designs (See http://en.wikipedia.org/wiki/Font for details)

Font Information—information describing a type face that includes font family, size, style (etc.) of the font being used, which may be part of an annotation mark record.

Windows® Metafile—Windows Metafile (WMF) is a graphic file format on Microsoft Windows systems originally designed in the early 1990s. It is a vector-based graphic format that also allows the inclusion of raster graphics. Essentially, a WMF file stores a list of function calls that may be issued to the Windows graphics layer GDI in order to restore the image.

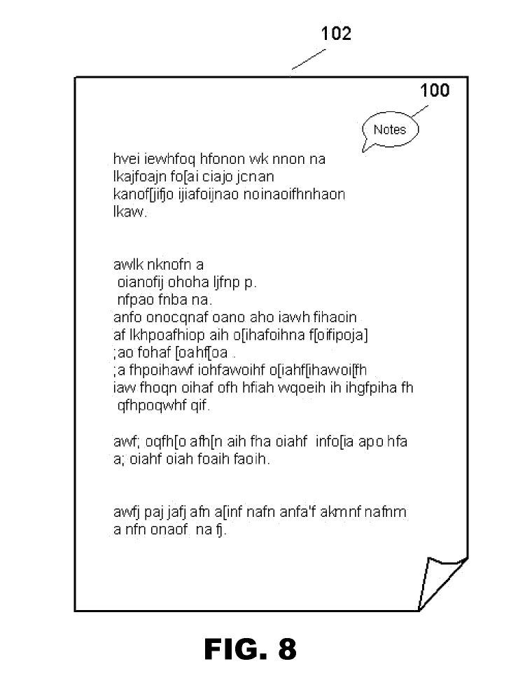

FIG. 8 illustrates an annotation 100, e.g., a note, generated by an author and placed on a document image 102 at a particular position (in this case, to draw attention to the first paragraph of the document image). When the author applies the annotation (using a computer “mouse” or keyboard), information associated with the annotation 100 (e.g., location of the annotation on the document, appearance, or other information) is written into the annotation file. Each annotation placed on the document image has an associated record in the annotation file, called an annotation mark record. FIG. 9 illustrates an annotation file 110 having multiple records 111, 112, 113, 114, and 115. In other words, there are as many annotation mark records in the file 110 as there are annotations applied by users to the document image.

Each annotation record contains a number of fields that include information about mark location, mark appearance (colors, line size and shape), and other information. A first field 120 may contain a record number, a second field 122 may contain information relating to the location of the annotation on the document image 102, a third field 124 may contain information relating to the appearance of the annotation, a fourth field 126 may identify the font type of annotation, and a fifth filed 128 may contain other information about the annotation (e.g., text, audio, etc.). Some annotations (such as “sticky” notes and stamps) can also contain font information that is used to render the appropriate font face on a hardware device (such as computer monitor or printer).

When the annotation file 110 is used on a different computer, it may happen that there exists no type font identified in field 126 installed on the rendering computer. When this happens, the rendering computer's operating system will try to substitute the type font with the closest font available, visually matching the font installed on its system. If there is no match found, the rendering computer system will substitute a default system font, whereupon an error is likely introduced into the appearance of annotation due to the missing font or imperfect font matching routine applied by the operating system of the rendering computer. As mentioned above, the appearance problem can dramatically affect usability of the annotations.

To resolve this problem, there is provided a way to preserve annotation appearance across different computers. This is achieved in the authoring computer system. Instead of providing “text” to represent the annotation, the annotation mark record is used to create an “image” of the annotation. This image basically is a “snapshot” of the annotation and captures the appearance of the annotation as the authoring user sees it. When the annotation file is used on another computer, the displaying computer system will render the snapshot image, instead of entering routines to reproduce “text” annotation from the annotation mark record. By “snapshot” it is meant to create an image file of the annotation.

An exemplary way to implement this feature is to provide another field 130 (FIG. 9) in the annotation record that contains an image annotation file. Thus, the records or marks in the annotation file would include an image file that displays the visual appearance of the annotation in a standard image format, e.g., GIF, JPEG, WMF, BMP, etc. The annotation image thus generated would then be overlaid on the original document image 102, or burned into the original document image, if desired.

If a user subsequently decides to modify the annotation 100, another snapshot will be taken to capture the new appearance of modified annotation, and this modified snapshot can replace the previous annotation image previously generated. The old annotation mark data may still be used to render the annotation while the user is modifying it and may still be persisted with the mark in annotation file.

Advantageously, the image of the annotation will not change when rendered to a device of another computer since a computer, regardless of the platform implemented or configuration thereof, will recreate the same image pixel-by-pixel.

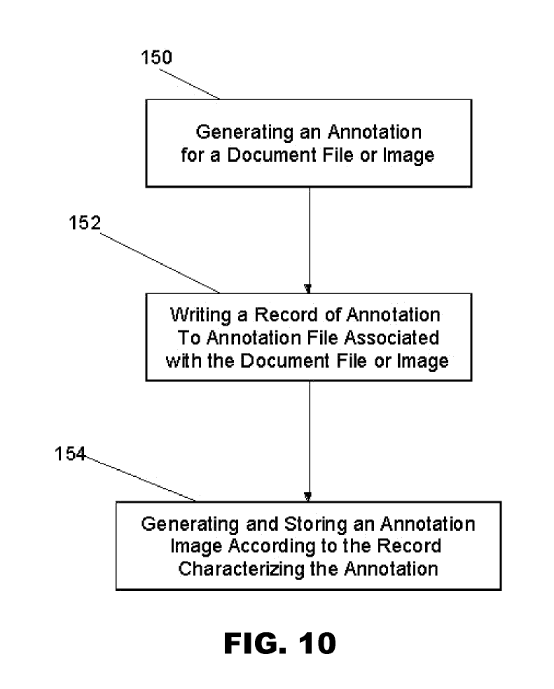

FIG. 10 illustrates a method according to an aspect of the present invention. The method comprises step 150 of generating an annotation for a document image, step 152 of writing a record in an annotation file to characterize the annotation, and step 154 of generating and storing an annotation image according to the record characterizing the annotation.

While this invention is not specific to any particular image format, it should be noted that some formats are better suited than others. For instance, it is general knowledge that certain formats are device-dependent and others are device-independent. For use with the present invention, device-independent fonts are more preferable in annotation authoring system because of the font's ability to be rendered in a consistent manner on different devices.

Another consideration concerns raster vs. vector image formats. A vector-based image format is more preferable because the annotation image will not lose quality while being scaled up and down in size. As such, an annotation image format such as “Windows® Metafile” has been found to be more appropriate than others. In a current implementation, it has been found that an EMF image format (“Enhanced Windows® Metafile”) provided very compact image file storage and was vector-based, which makes it a good candidate for use with the present invention.

Based on the teachings herein, the illustrated embodiments may be altered without departing from the scope of invention.

I claim:

1-7. (canceled)

8. A computer-implemented method of uniformly rendering electronic annotations in relation to a document file when displayed devices of at least two computers, said method comprising:
producing an annotation to be overlaid on and displayed with said document file, said annotation having a size and appearance in relation to the document file,
generating an image of the annotation to capture said size and an appearance in relation to the document file,
storing the annotation in a scalable image format, and
prior to displaying the document file and overlaid annotation on respective display devices of said at least two computers, re-scaling the size and appearance of the annotation in relation to the document file to the same size and appearance generated during the generating step whereby to render a uniform annotation in relation to the document file when displayed on said at least two computers.

9. The method of claim 8, wherein during said appearance includes colors, line size and shape of said annotation.

10. The method of claim 8, wherein said storing step comprises storing the annotation image in a record of an annotation file along with attributes of said document file, and said re-scaling step comprises accessing the record to retrieve and render said combined image of said document file and annotation image.

11. The method of claim 8, wherein said storing step comprises storing a pointer for the annotation image in a record of an annotation file, and said re-scaling step comprises accessing said record to retrieve said pointer in order to retrieve and render said combined image of said document file and annotation image.

12. The method of claim 8, wherein said generating step includes generating said annotation image in vector-based image format.

13. A computer-implemented method of uniformly rendering annotations for a document stored in memory across computers having different image-rending configurations, said method comprising:
utilizing a first computer to generate an annotation overlaid on said document according to a rendering size and appearance of a first computer; to produce attributes for said annotation that represent said rendering size and appearance; to produce an annotation image of the annotation; and to store the annotation image and attributes in an annotation file; and
utilizing a second computer to access the document and annotation file; and prior to displaying said document file and overlaying said annotation image on said document file, utilizing said attributes to re-scale said annotation to render said document and annotation image according to the same size and appearance generated by said first computer.

14. The method of claim 13, wherein said storing step comprises storing the annotation image and attributes in a record of said annotation file and said accessing step includes accessing said record to retrieve the annotation image and annotation attributes.

15. A computer-readable medium to store executable program instructions to effect operation of a computer-implemented imaging system to enable a user to uniformly render a document and overlaid annotation originally created on a first computer, said instructions being operative to enable a second computer to access a memory containing the document and image files, to utilize attributes of said originally created document and annotation to re-scale the annotation in relation to the document to re-produce the document and overlaid image on said second computer in the same manner as originally created on said first computer, and to visually render on said second computer a representation of the document file and annotation image according to said attributes.

16. The computer-readable medium of claim 15, wherein said memory includes an image file server that stores said document and annotation, and said program instructions effect accessing and retrieval of said document and annotation from said image file server prior to rendering said document and overlaid annotation.

17. The computer-readable medium of claim 16, wherein said memory includes a record of an annotation file that stores said annotation image and associated attributes, and said program instructions effect accessing and retrieval of said annotation image and associated attributes from said record in order to render said document and overlaid annotation.
